(19) United States
(12) Patent Application Publication
(10) Pub. No.: US 2009/0140512 A1
(43) Pub. Date: Jun. 4, 2009

(54) Devices and Methods for Supporting Printed Mattter

(76) Inventor: Rania Nabil El-Sorrogy, Barrington, IL (US)

Correspondence Address: MOAZZAM & ASSOCIATES, LLC, 7601 LEWINSVILLE ROAD, SUITE 304, MCLEAN, VA, 22102, US

(21) Appl. No.: 12/255,593

(22) Filed: Oct. 21, 2008

Related U.S. Application Data
(63) Continuation-in-part of application No. 11/797,100, filed on Apr. 30, 2007.

(51) Int. Cl. B42D 17/00; B42D 15/00; B42C 11/00

(52) U.S. Cl. 281/45; 283/64; 412/4

(57) ABSTRACT

A book block is contemplated to be bound in its individual sections through various techniques. These sections will be attached to the book cover and/or additional sections by a mechanical way. The user of the book will then be allowed to select and detach individual sections of the book without destroying the integrity of the entire book block. Likewise, publishers of the book are now able to update and/or replace sections of an entire book block without needing to reprint and republish the whole book.

This application is a continuation-in-part of U.S. patent application Ser. No. 11,797,100, filed Apr. 30, 2007, which claims priority to U.S. Provisional Patent Application Ser. No. 60/796,167, filed Apr. 28, 2006, the contents of which are hereby incorporated by reference in their entirety into this disclosure.

### BACKGROUND OF THE INVENTION

1. Field of the Invention

The present invention relates to supporting of printed matter. In particular, the present invention relates to the support of various reading and/or viewing printed material including books, brochures, catalogs and the like.

2. Background of the Invention

As the volume of literature increases, additional costs are associated with the manufacture of printed Material, including books, brochures, catalogs, magazines, and the like. Some of this printed matter becomes very large or heavy, particularly because of their tremendous volume or size. Despite the advancement of literature and information, conventional methods of manufacture in the art of bookbinding have been relatively constant and have essentially been limited to (i) case binding and (ii) perfect binding. Traditional Smyth sewn books require a series of arranging, sewing, and gluing steps to adhere signatures (sections of the entire book) to the cover spine. Typically, textbooks and other large-mass books employ the Smyth sewn binding technique.

Perfect bound books mainly require an adhesive binding between the book block and the cover. After the technological booms following World War II, perfect binding became an economical option for many publishers, making it a common practice in contemporary times. Nearly all paperback books, telephone books, and other small-mass books are bound using the perfect binding technique.

Large-mass books are typically perfect bound or bound using the Smyth sewn technique. Many of these large-mass books are published in the form of textbooks or trade books for school students. Such large and heavy books take their toll on those who have to carry these books on a daily or regular basis, typically students. The American Chiropractic Association (ACA) and the American Occupational Therapy Association (AOTA) states that children should not carry more than 10% of their bodyweight. Researchers have found, however, that children are carrying 22% of their bodyweight in studies conducted in the United States.

The National Safety Council states that according to the US Consumer Product Safety Commission there were more than 21,000 backpack related injuries that ended up being treated in emergency rooms, clinics and doctors' offices in 2003. The range of these injuries was widespread from contusions, to sprains, and even fractures.

Some subject matters require new versions of texts in order to account for changes that took place after the initial publication of the book. Using bookbinding methods of the art, the entire text is replaced when revisions are made to a sufficient number of sections. Some fields, such as legal texts, use “pocket parts,” which are smaller independent sections showing only the changes; but the main body of text is unchanged, and both the main body of text and the pocket part must be referenced in order to read the actual updated text. Using existing techniques of the art, there is no other way to replace merely a section of the book.

Thus, there is a need in the art for a more effective technique for manufacturing printed matter such that portions of the printed matter may be carried independently of the other portions, and allowed to be changed, revised or replaced without having to do so for the entire volume in which such portion is a part. The technique should be simple to understand, use and manufacture so that it provides an efficient and less costly alternative to constant volume changes and/or provides an efficient method of carrying just one portion of a large size or volume printed matter.

### SUMMARY OF THE INVENTION

The present invention provides a unique technique of assembling, organizing and/or manufacturing bound or unbound printed matter such that such matter may be easily taken apart into defined portions and each portion carried or reviewed independently of the other. Though examples throughout this application may focus on particular types of printed matter for sake of simplicity, it should be known that the techniques disclosed here are applicable to all types of matter having multiple portions as would be evident to one having ordinary skill in the art after consideration of the present disclosure. Each such portion can also be independently updated or revised without affecting the other portions of the matter that have not been changed. The present invention overcomes many disadvantages associated with conventional bookbinding and manufacturing techniques by using a novel and simple technique of combining interlocking components that comprise sections of a reading material, such as a book. Book users need not transport the entirety of a book when they only desire to focus on one chapter or section of the book. With the present invention, the book user can select the portion(s) of the book she would like to carry with her. Likewise, book publishers need not reprint the entirety of a book when they desire to alter select chapters or sections of the book. With the present invention, the book publisher can select portion(s) of the book that it would like to update, reprint, and sell. Such technique is more advantageous to the publisher, because only certain portions of a, for example, textbook are revised and the cost of printing is limited to those particular portions, such as a chapter. That individual portion can then be sold at a substantially reduced rate than having to reprintand sell the entire textbook. Such high costs of having to re-publish an entire book also prevent many buyers from purchasing new versions because of the lack of substantial difference from older versions of the same textbook. Thus, with the present technique, the publishers can realize higher sales of relevant portions of a textbook because consumers are more apt to purchase those portions of a textbook that are updated rather than an entirely reprinted new textbook.

Using techniques presented herein and according to the present invention, portions or sections of a book will be individually bound, such as, but not limited to, a perfect binding method. These smaller sections of the whole textbook could be gathered under a book cover. The force used for attraction between the sections and the book cover would be strong enough to keep the entire book block together, when this is the desired use. The sections can also be detached from the book cover and carried separately. A few examples of forces used for attaching the detachable sections include magnetic and mechanical techniques.

For sake of simplicity, exemplary techniques that may be used in conjunction with the present invention have been presented in various groups of embodiments. Also, for sake of simplicity, the various embodiments are presented with use of a “book” for sake of simplicity. However, the present invention and techniques are equally applicable to other forms of printed and bound and unbound matter, including but not limited to, magazines, directories, newspapers, brochures, photographic albums, and the like. In a non-limiting example of unbound material, techniques disclosed in the present invention may be used to assemble previously unbound materials into a cohesive unit, as well as serving as binding for different sections of the unbound printed matter. One of ordinary skill in the art would be cognizant of these and other type of printed or photographic matter that could be used by the techniques presented in the present disclosure. All such uses are within the scope of the present invention.

The mechanical embodiments explained in the present invention provide mechanical methods of fastening the sections to the book cover or fastening the book sections to one another. Examples of mechanically-attaching mechanisms include but are not limited to a series of interlocking convexities and concavities, such as a tongue and groove mechanism. Many other mechanical binding devices may be used and such other devices are apparent to one having ordinary skill in the art and thereby within the scope of the present invention.

The sections (or chapters) of a sectional book constructed using the mechanical method can be mechanically-adhered to the book cover or each other, so that each section may be independently separated from the entire book block. Thus, sections of the book can be individually bound, and the book cover and/or section covers can include at least one mechanically-attaching member.

The present invention has many uses and advantages as would be apparent to one having ordinary skill in the art after consideration of the present disclosure. Exemplary non-limiting uses and advantages over conventional techniques include, but are not limited to: providing a convenient way for users to select which portions of a book to carry with them; providing a reduction in overall weight carried by the user in the forms of books; providing a way for reducing back-related injuries due to carrying heavy books; providing book publishers a way to update portions of the book without need to reprint the entire book; providing book publishers a way to reduce their overall cost of production for new and/or updated versions of books.

### BRIEF DESCRIPTION OF THE DRAWINGS

FIG. 1 shows an alternative enforced tension-release mechanism between section members, with a hinged member which is secured into a complimentary member that temporarily locks the section members into place, according to an exemplary embodiment of the present invention.

FIG. 2 shows an alternative enforced tension-release mechanism between section members, with a straight member which is secured into a complimentary member that temporarily locks the section members into place, according to an exemplary embodiment of the present invention.

FIG. 3A shows a curved tension-release groove mechanism between section member and book cover wherein one or more unique convexities are placed along spine region of the section member and at least one complimentary unique concavity is placed along the interior of the spine region of the book cover, according to an exemplary embodiment of the present invention.

FIG. 3B depicts enlarged view of FIG. 3A, with a focus on the connecting mechanism between section member and book cover.

FIG. 4A shows an interlocking curved tension groove mechanism between section member and book cover wherein the interlocking mechanism is flexible and allows the section members to rotate along the axis created by the unique elements that snap one section member into another section member and one or more unique convexities are placed along spine region of the section member, and at least one complimentary unique concavity is placed along the interior spine region of the book cover, according to an exemplary embodiment of the present invention.

FIG. 4B depicts enlarged view of FIG. 4A, with a focus on the connecting mechanism between section member and book cover.

FIG. 5A shows a curved tension-release groove mechanism between section members with one or more convexities are placed along one edge of the section member's spine region and at least one complimentary concavity is placed along the opposite edge of the section member's spine region, such that the concavities are perpendicular to the section member's cover, according to an exemplary embodiment of the present invention.

FIG. 5B depicts enlarged view of FIG. 5A, with a focus on the connecting mechanism between section members.

FIG. 6A shows an interlocking curved tension groove mechanism between section members wherein the interlocking mechanism is flexible and allows the section members to rotate along the axis created by the unique elements that snap one section member into another section member and one or more unique convexities are placed along one edge of the section member's spine region, with at least one complimentary unique concavity is placed along the same plane and opposite edge of the section member's spine region, such that the concavities are perpendicular to the section member's cover, according to an exemplary embodiment of the present invention.

FIG. 6B depicts enlarged view of FIG. 6A, with a focus on the connecting mechanism between section members.

FIG. 7A shows an alternative curved tension groove mechanism between section members wherein one or more convexities are placed along one edge of the section member's spine region and at least one complimentary concavity is placed along the same plane and opposite edge of the section member's spine region, such that the concavities are perpendicular to the section member's cover, and wherein these concavities are also flush with the edge of the spine region of the section member, according to an exemplary embodiment of the present invention.

FIG. 7B depicts enlarged view of FIG. 7A, with a focus on the connecting mechanism between section members.

FIG. 8A shows an interlocking curved tension groove mechanism between section members wherein this interlocking mechanism is flexible and allows the section members to rotate along the axis created by the unique elements that snap one section member into another section member, with one or more unique convexities are placed along one edge of the section member's spine region, and at least one complimentary unique concavity is placed along the same plane and opposite edge of the section member's spine region, such that the concavities are perpendicular to the section member's cover, and these concavities are also flush with the edge of the spine region of the section member, according to an exemplary embodiment of the present invention.

FIG. 8B depicts enlarged view of FIG. 8A, with a focus on the connecting mechanism between section members

FIG. 9A shows an angled tension groove mechanism between section members such that the complimentary tongue may snap into various areas of the complimentary groove wherein this interlocking mechanism is flexible and allows the section members to rotate along the axis created by the unique elements that snap one section member into another section member and one or more unique attaching members are placed along the section member's spine region, and wherein this unique attaching member composes both the concave snapping tension element and the complimentary unique concavity, and the concavities are parallel to the section member's cover and are also flush with the edge of the spine region of the section member, according to an exemplary embodiment of the present invention.

FIG. 9B depicts enlarged view of FIG. 9A, with a focus on the connecting mechanism between section members.

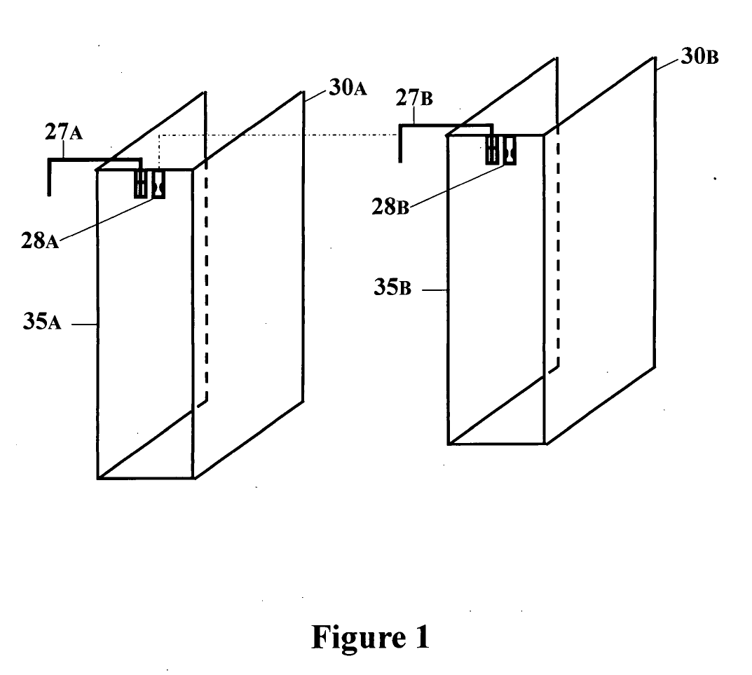

FIG. 1OA shows an angled groove channel mechanism between section members such that the complimentary tongue may snap into various areas of the complimentary groove wherein this interlocking mechanism is flexible and allows the section members to rotate along the axis created by the unique elements that snap one section member into another section member, and one or more unique attaching members are placed along the section member's spine region, and this unique attaching member composes both the concave snapping tension channel element and the complimentary unique concavity, and the concavities are parallel to the section member's cover and are also flush with the edge of the spine region of the section member, according to an exemplary embodiment of the present invention.

FIG. 10B depicts enlarged view of FIG. 10A, with a focus on the connecting mechanism between section members.

FIG. 11A shows an alternative angled tension groove mechanism between section members such that the complimentary tongue may snap into various areas of the complimentary groove wherein this interlocking mechanism is flexible and allows the section members to rotate along the axis created by the unique elements that snap one section member into another section member, and wherein one or more unique convexities are placed along one edge of the section member's spine region, and at least one complimentary unique concavity is placed along the same plane and opposite edge of the section member's spine region, such that the concavities are parallel to the section member's cover, and are also flush with the edge of the spine region of the section member, according to an exemplary embodiment of the present invention.

FIG. 11B depicts enlarged view of FIG. 11A, with a focus on the connecting mechanism between section members.

FIG. 12A shows an interlocking tension groove channel mechanism between section members such that the complimentary tongue may snap into various areas of the complimentary groove wherein this interlocking mechanism is flexible and allows the section members to rotate along the axis created by the unique elements that snap one section member into another section member, and wherein one or more unique convexities are placed along one edge of the section member's spine region, and at least one complimentary unique concave channel is placed along the same plane and opposite edge of the section member's spine region, such that the concavities are parallel to the section member's cover and are also flush with the edge of the spine region of the section member, according to an exemplary embodiment of the present invention.

FIG. 12B depicts an enlarged view of FIG. 12A, with a focus on the connecting mechanism between section members.

FIG. 13A shows a simple tension channel mechanism between section member and book cover with one or more convexities are placed along the spine region of the section member and at least one complimentary tension channel is placed along the interior of the spine region of the book cover, according to an exemplary embodiment of the present invention.

FIG. 13B depicts an enlarged view of FIG. 13A, with a focus on the connecting mechanism between section member and book cover.

FIG. 14A shows an alternative interlocking tension channel mechanism between section member and book cover that allows the unique concavity to snap into a complimentary unique concavity wherein this interlocking mechanism is flexible and allows the section members to rotate along the axis created by the unique elements that snap one section member into another section member, and wherein one or more unique convexities are placed along the spine region of the section member, and at least one complimentary tension channel with interlocking element is placed along the interior of the spine region of the book cover, according to an exemplary embodiment of the present invention.

FIG. 14B depicts an enlarged view of FIG. 14A, with a focus on the connecting mechanism between section member and book cover.

FIG. 15A shows an alternative interlocking tension channel mechanism between section member and book cover that allows the unique concavity to snap into a complimentary unique concavity, and wherein this interlocking mechanism is flexible and allows the section members to rotate along the axis created by the unique elements that snap one section member into another section member, and wherein at least one unique interlocking groove element with at least two channel openings is placed along the interior of the spine region of the book cover, and at least one complimentary convexity with interlocking element is attached to spine region of the section member, according to an exemplary embodiment of the present invention.

FIG. 15B depicts an enlarged view of FIG. 15A, with a focus on the connecting mechanism between section member and book cover.

FIG. 16A shows a simple tension channel mechanism between section members wherein one or more convexities are placed along the edge of the section member's spine region and wherein at least one complimentary tension channel is attached to the opposite edge of the section member's spine region, and the channel openings are perpendicular to section member's cover and are flush with the edge of the spine region of the section member, according to an exemplary embodiment of the present invention.

FIG. 16B depicts an enlarged view of FIG. 16A, with a focus on the connecting mechanism between section members.

FIG. 17A shows an alternative interlocking tension channel mechanism between section members that allows the unique concavity to snap into a complimentary unique concavity wherein this interlocking mechanism is flexible and allows the section members to rotate along the axis created by the unique elements that snap one section member into another section member and wherein one or more unique convexities are placed along the edge of the section member's spine region and at least one complimentary tension channel with interlocking element is attached to the opposite edge of the section member's spine region, and wherein the channel openings are perpendicular to section member's cover and are flush with the edge of the spine region of the section member, according to an exemplary embodiment of the present invention.

FIG. 17B depicts an enlarged view of FIG. 17A, with a focus on the connecting mechanism between section members.

FIG. 18A shows an alternative interlocking tension channel mechanism between section members that allows the unique concavity to snap into a complimentary unique concavity, wherein this interlocking mechanism is flexible and allows the section members to rotate along the axis created by the unique elements that snap one section member into another section member and wherein at least one unique interlocking groove element with at least two channel openings is placed along the edge of the section member's spine region and wherein at least one complimentary unique convexity with interlocking element is attached to the opposite edge of the section member's spine region, and wherein the channel openings are perpendicular to section member's cover and are flush with the edge of the spine region of the section member, according to an exemplary embodiment of the present invention.

FIG. 18B depicts an enlarged view of FIG. 18A, with a focus on the connecting mechanism between section members.

FIG. 19 shows various alternative spine regions for section members, according to exemplary embodiments of the present invention.

FIG. 20A shows an example of adding a unique attaching mechanism as described in previous embodiments of the present invention to an alternative spine region, which is then attached to the spine region of the section member.

FIG. 20B depicts an enlarged view of FIG. 20A, with a focus on the connecting mechanism between section members.

### DETAILED DESCRIPTION OF THE INVENTION

As disclosed in the present description and accompanying drawings, the present invention provides for manufacture, sale, and use of a printed matter incorporating reversibly detachable sections.

To assist in the consideration of the present disclosure and accompanying drawings, the following labels have been used and are generally presented here and described in more detail below:

10: Book cover

15: Spine region of book cover

27 A, B: Durable hinged rod

28 A, B, C, D: Complimentary enforced tension-release groove

29 A, B, C, D: Durable linear rod

30 A, B: Section member

35 A, B: Spine region of section member

38: Alternative spine region of section member

39: Alternative spine region of section member with detachable elements

41 A, B: Alternative durable linear rod

42 A, B: Alternative complimentary enforced tension-release groove

43 A, B: Complimentary curved convex attaching member

44 A, B: Complimentary curved tension groove

45 A, B: Complimentary curved convex attaching member containing interlocking element

46 A, B: Complimentary groove attaching member containing interlocking element

47 A, B, C, D: Complimentary curved tension groove and attaching member

48 A, B, C, D: Alternative complimentary curved tension groove with interlocking element

49 A, B, C, D: Unique complimentary attaching members with multiple tension grooves

50 A, B, C, D: Unique complimentary attaching members with multiple tension grooves and channel guide

51 A, B, C, D: Bent rod attaching member

52 A, B, C, D: Alternative unique complimentary concave attaching members with multiple tension grooves

53 A, B, C, D: Alternative unique complimentary concave attaching members with multiple tension grooves and channel guide

54 A, B, C, D: Complimentary tension channel attaching member

55 A, B, C, D: Complimentary convex attaching member

56 A, B, C, D: Alternative interlocking tension channel attaching member

57 A, B, C, D, E, F, G, H: Alternative complimentary interlocking convex attaching member

58 A, B, C, D: Alternative complimentary interlocking tension channel attaching member

The following is a non-limiting list of exemplary mechanical embodiments of the present invention. The section members 30A and 30B can be attached to the book cover 10 through adjoining members. Section members 30A and 30B can also be attached to each other. Combinations of attaching the section member 30A and/or 30B and book cover 10 by adjoining members include but are not limited to (i) tongue-groove, (ii) groove-tongue, (iii) tension-release, (iv) enforced tension-release, (v) interlocking hinge mechanisms. Combinations of attaching the section member 30A to 30B by adjoining members include but are not limited to (i) tongue-groove, (ii) groove-tongue, (iii) tension-release, (iv) enforced tension-release, (v) interlocking hinge mechanisms.

The attaching members of these embodiments are made of flexible and durable materials (such as plastic and/or rubber and/or metal), which would be affixed to the book cover and/or section member(s). These members may be affixed in a variety of permanent or non-permanent ways, such as gluing, taping, sewing, clasping, crimping, or interlocking. Thus, the attaching mechanism may be reversible or irreversible, depending on the desire of the user. The most likely method for affixing members described in the tongue and groove embodiments is gluing, while the tension snapping embodiments may require additional strength by employing additional sewing and/or crimping. The composition base of the adhesive used to affix attaching members to the book cover and/or section members may include but is not limited to a polyvinyl acetate (PVA), resin, ground animal, ground hide, liquid hide, or caoutchouc (raw rubber).

FIG. 1 shows an enforced tension-release mechanism between section member 30A and section member 30B. Durable hinged rod 27B is attached to the spine region 35B of section member 30B. A complimentary open groove 28A contains flexible durable elements along its open surface, narrowing the voidable space along this plane. This groove member 27A is attached to the spine region 35A of section member 30A. This arrangement will allow the section member 30A to attach to section member 30B by applying force and inserting unique convexity 27B into the complimentary unique concavity 28A, effectively overcoming the tension between the narrow open areas along the surface of concavity 28A, effectively securing the section members to each other.

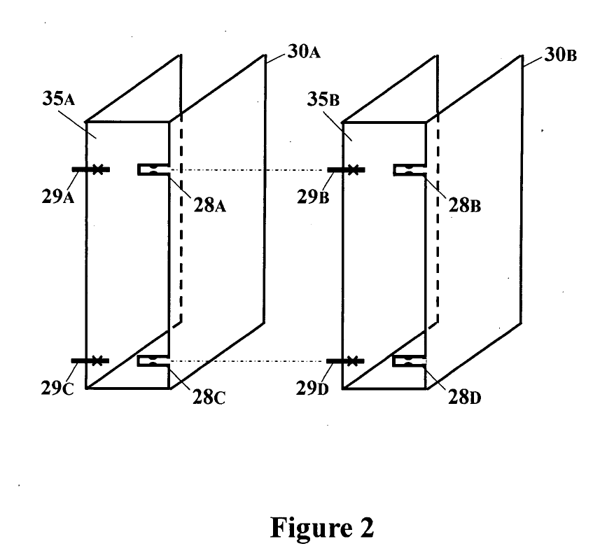

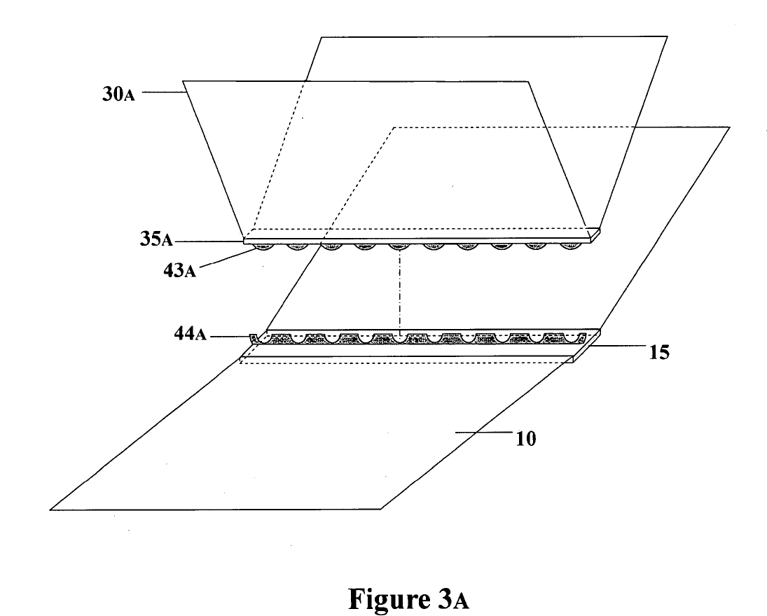

FIG. 2 shows an alternative enforced tension-release mechanism between section member 30A and section member 30B. Durable linear rods 29B and 29D are attached to the spine region 35B of section member 30B. Complimentary open grooves 28A and 28C contain flexible durable elements along its voidable groove surface, narrowing the voidable space along this plane. These groove members are attached along the opposite edge of spine region 35A of section member 30A. This arrangement will allow the section member 30A to attach to section member 30B by applying force and inserting unique convexities 29B and 29D into the complimentary unique concavities 28A and 28C, effectively overcoming the tension between the narrow open areas along the surface of concavities 28A and 28B, securing the section members into place.

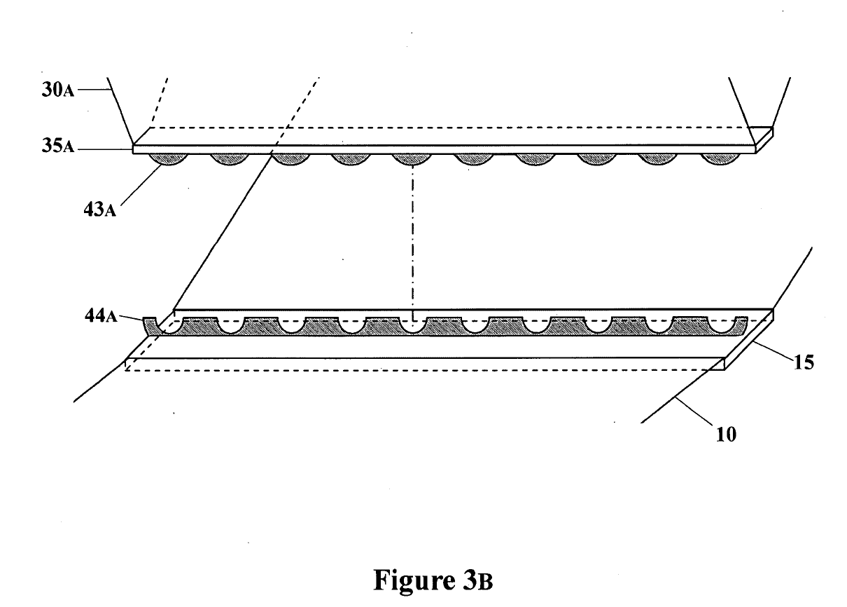

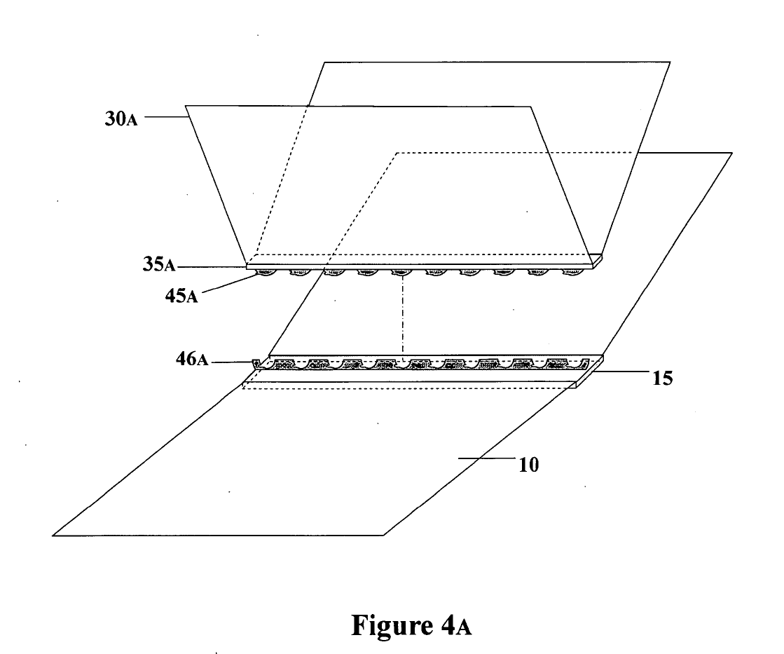

FIGS. 3A and 3B depict a curved tension-release groove mechanism between section member 30A and book cover 10. Unique convexity 43A compliments the unique complimentary concavities 44A. In this embodiment, convexity 43A is placed along the spine region 35A of section member 30A. The complimentary unique concavity 44A is located along the interior of spine region 15 of book cover 10. This arrangement will allow the section member 30A to attach to book cover 10 by inserting unique convexity 43B into the complimentary unique concavity 44A.

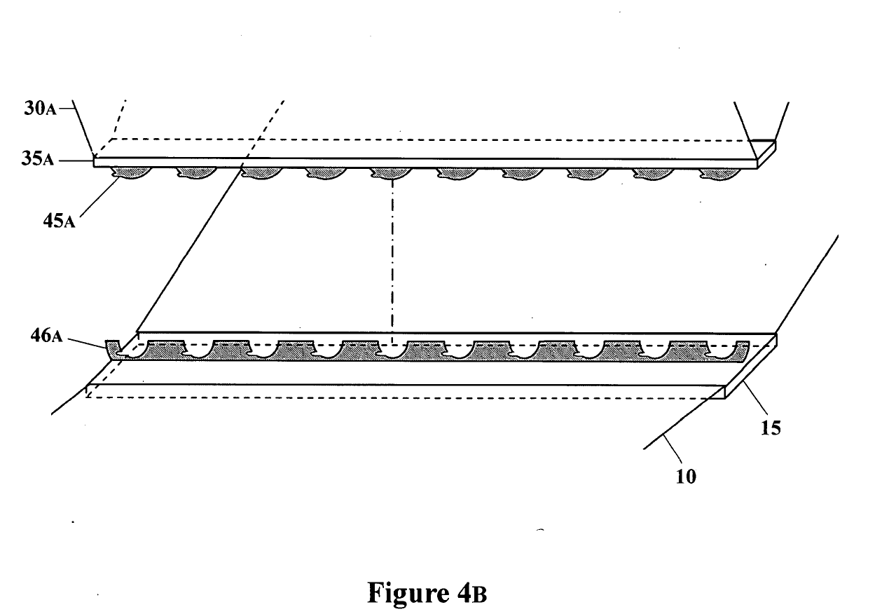

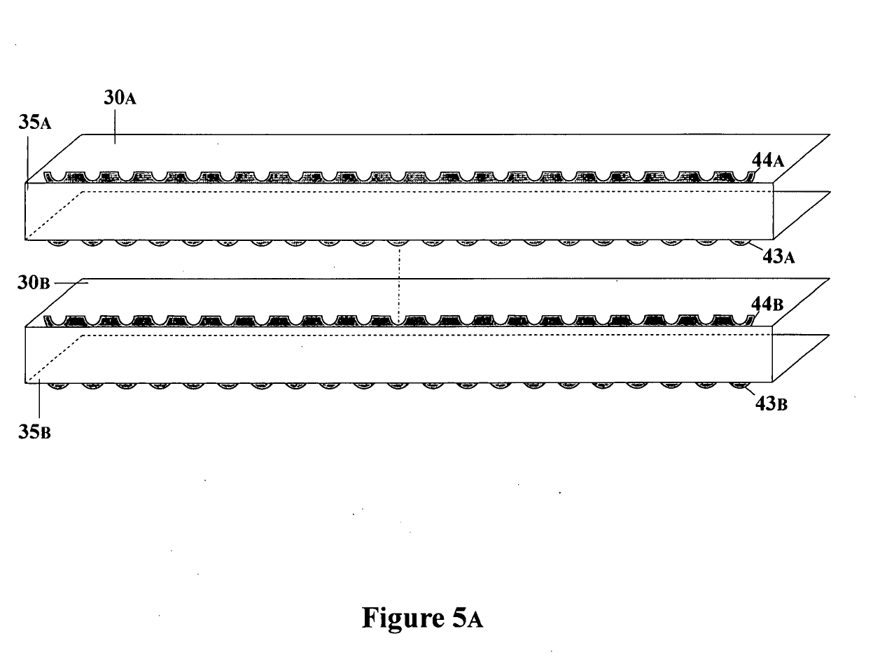

FIGS. 4A and 4B depict an interlocking curved tension-release groove mechanism between section member 30A and book cover 10. Unique convexity 45A compliments the unique complimentary concavities 46A. In this embodiment, convexity 45A is placed along the spine region 35A of section member 30A. The complimentary unique concavity 46A is located along the interior of spine region 15 of book cover 10. This arrangement will allow the section member 30A to attach to book cover 10 by inserting and adjoining unique convexity 45A into the complimentary unique concavity 46A. The unique adjoining elements in attaching member 45A allows attached section members 30A and 30B to rotate around the axis created by these unique adjoining elements and complimentary unique adjoining elements in attaching members 46A.

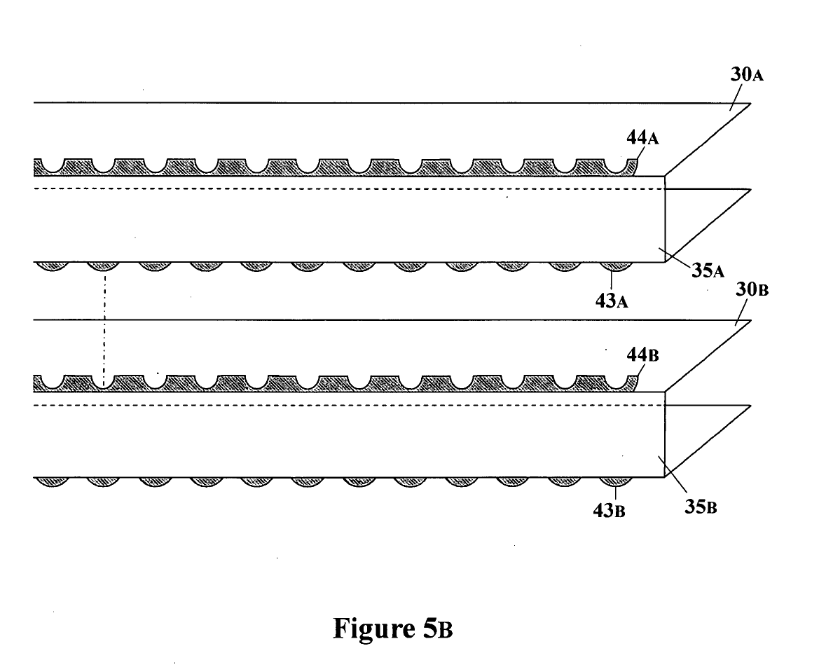

FIGS. 5A and 5B depict a curved tension-release groove mechanism between section member 30A and section member 30B. Unique convexities 43A and 43B compliment the unique complimentary concavities 44A and 44B. In this embodiment, convexity 43B and concavity 44B are located on parallel planes near the spine region 35B of section member 30B. In this embodiment, convexity 43A and complimentary concavity 44A are located on parallel planes the spine region 35A of section member 30A. This arrangement will allow the section member 30A to attach to section member 30B by inserting unique convexity 43A into the complimentary unique concavity 44B.

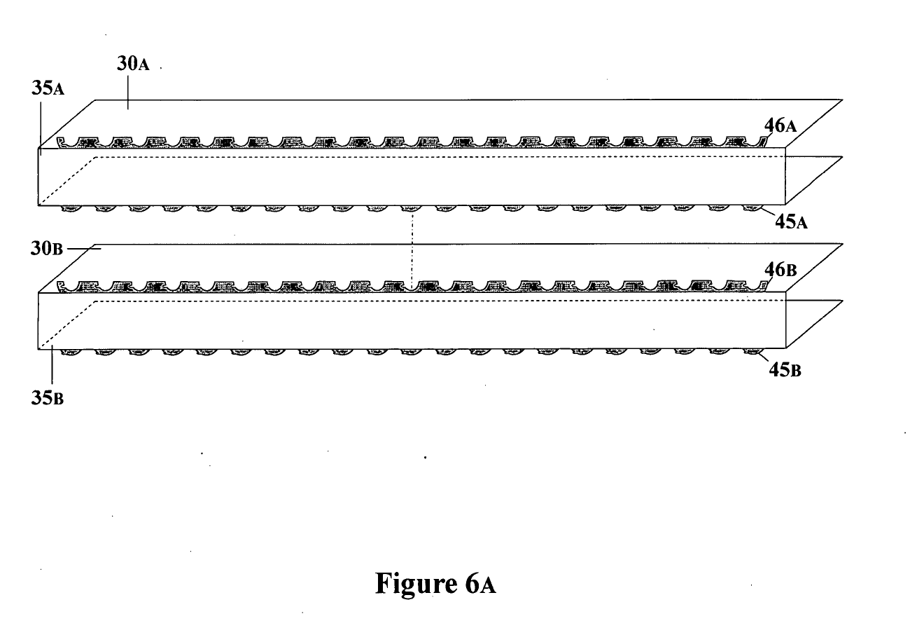

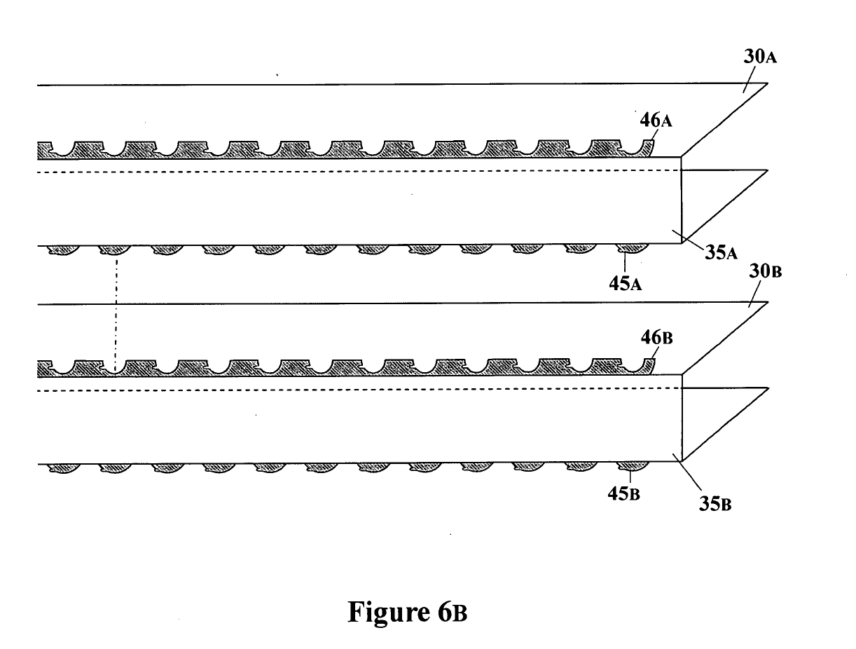

FIGS. 6A and 6B depict an interlocking curved tension-release groove mechanism between section member 30A and section member 30B. The unique convexities of 45A and 45B compliment the unique concavities of 46A and 46B. In this embodiment, convexity 45B and concavity 46B are located on parallel planes along the spine region 35B of section member 30B. In this embodiment, convexity 45A and concavity 46A are located on parallel planes along the spine region 35A of section member 30A. This arrangement will allow the section member 30A to attach to section member 30B by inserting and adjoining unique convexity 45A into the complimentary unique concavity 46B. The unique adjoining elements in attaching member 45A allows attached section members 30A and 30B to rotate around the axis created by these unique adjoining elements and complimentary unique adjoining elements in attaching members 46B.

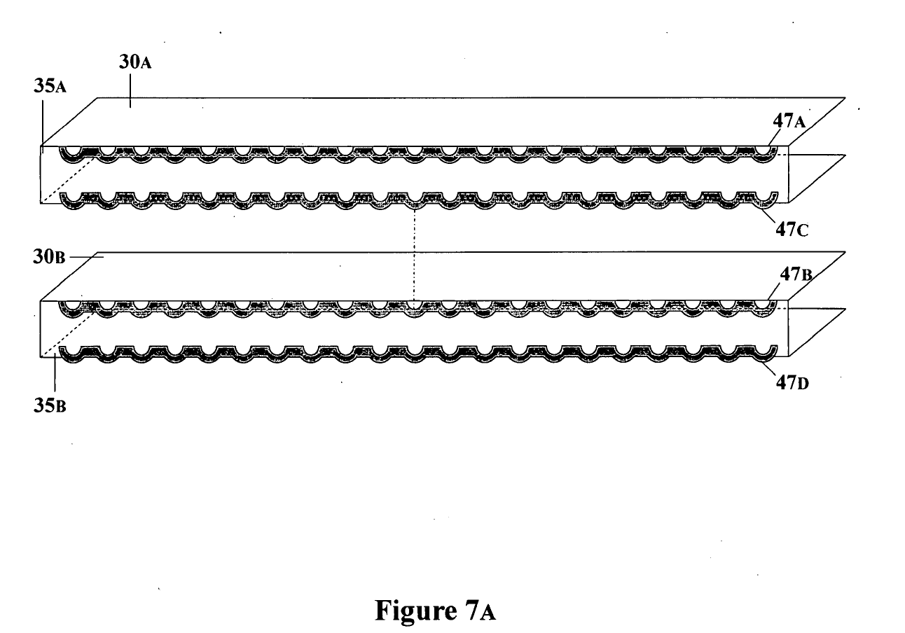

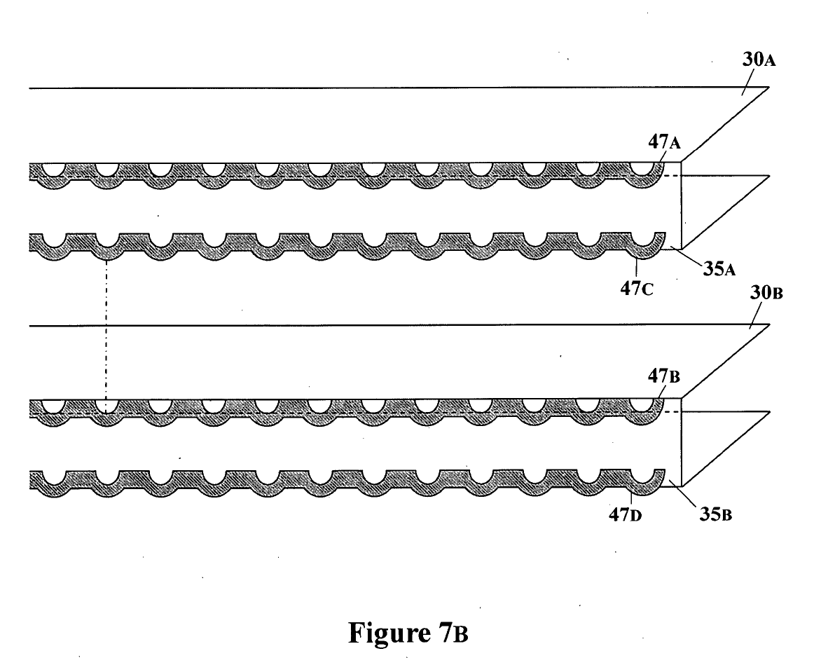

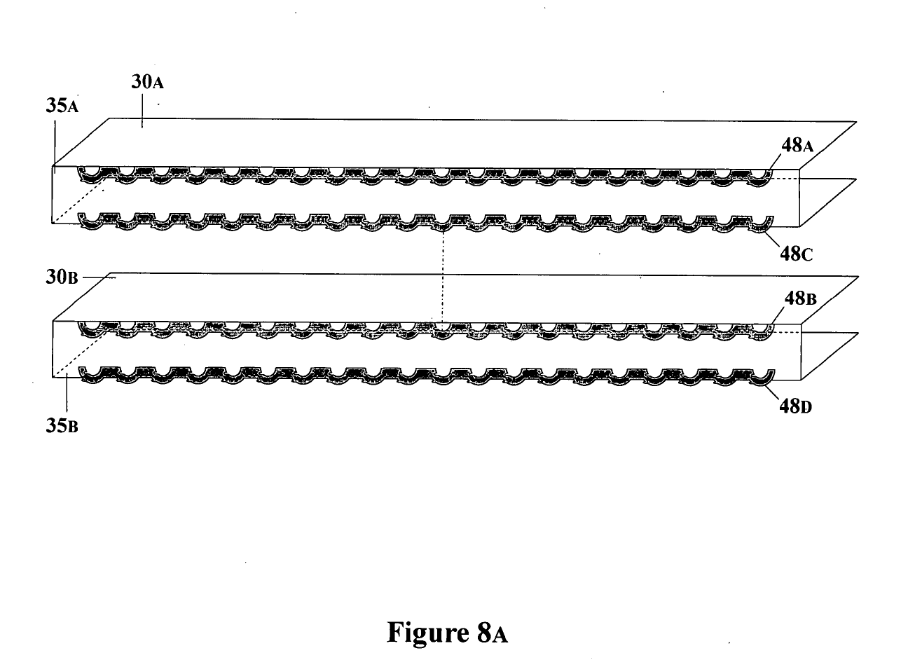

FIGS. 7A and 7B depict an alternative curved tension-release groove mechanism between section member 30A and section member 30B. The unique convexities of 47C and 47D compliment the unique concavities of 47A and 47B. In this embodiment, convexity 47B and concavity 47D are located along parallel planes along the spine region 35B of section member 30B, such that unique concavity 47B is flush with the cover of section member 30B. In this embodiment, convexity 47A and concavity 47C are located on parallel planes along the spine region 35A of section member 30A, such that unique concavity 47A is flush with the cover of section member 30A. This arrangement will allow the section member 30A to attach to section member 30B by inserting unique convexity 47C into the complimentary unique concavity 47B.

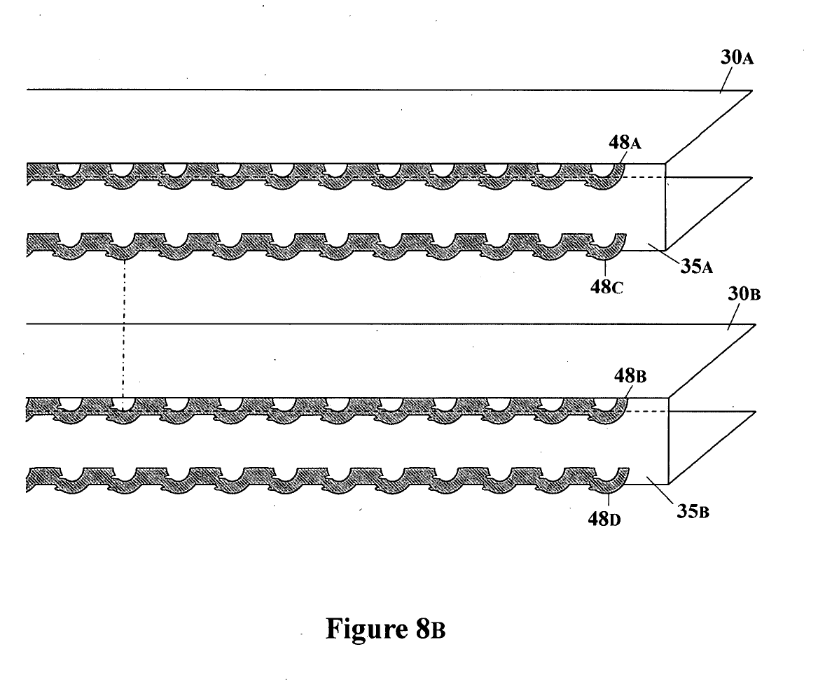

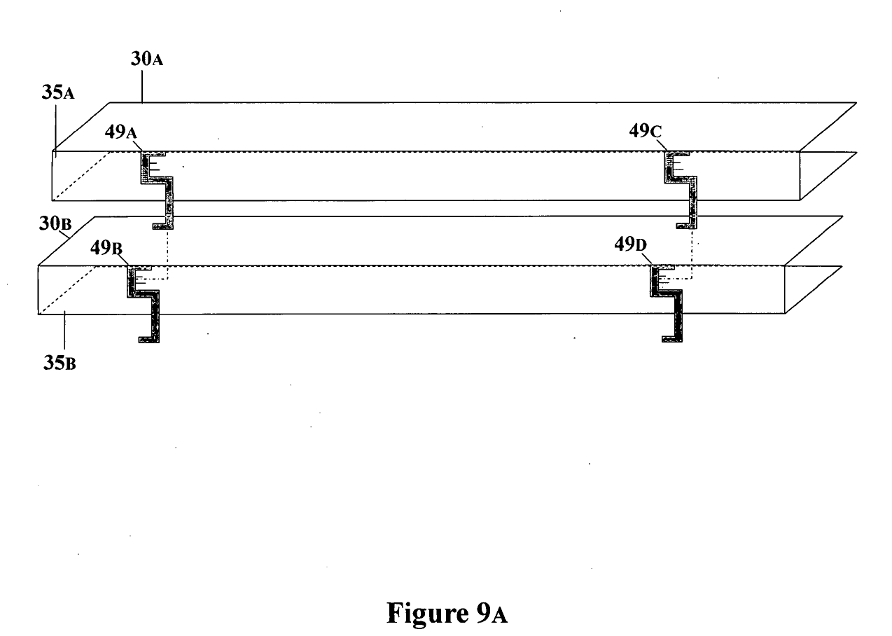

FIGS. 8A and 8B depict an interlocking curved tension-release groove mechanism between section member 30A and section member 30B. The unique convexities of 48C and 48D compliment the unique concavities of 48A and 48B. In this embodiment, convexity 48B and concavity 48D are located on parallel planes along the spine region 35B of section member 30B, such that unique concavity 48B is flush with the cover of section member 30B. In this embodiment, convexity 48A and concavity 48C are located on parallel planes along the spine region 35A of section member 30A, such that the unique concavity 48A is flush with the cover of section member 30B. This arrangement will allow the section member 30A to attach to section member 30B by inserting and adjoining unique convexity 48C into complimentary unique concavity 48B. The unique adjoining elements in attaching member 48A allows attached section members 30A and 30B to rotate around the axis created by these unique adjoining elements and complimentary unique adjoining elements in attaching members 48B.

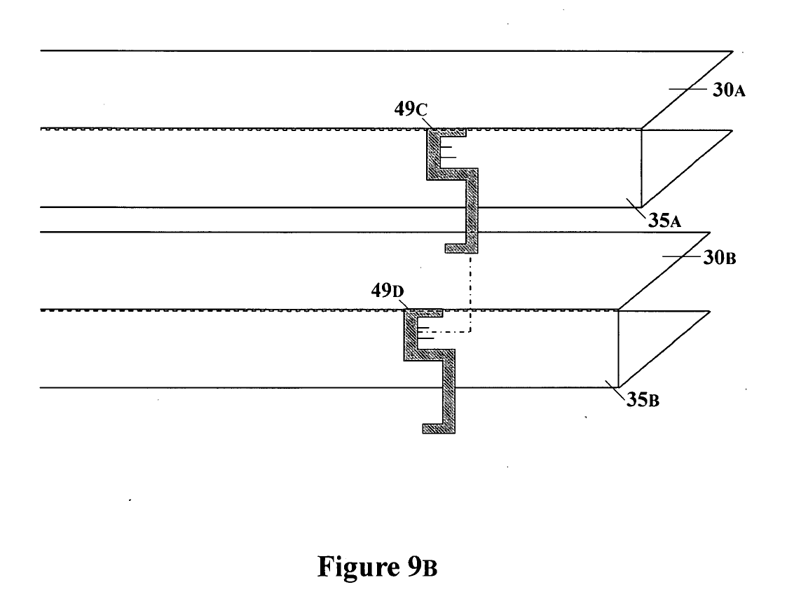

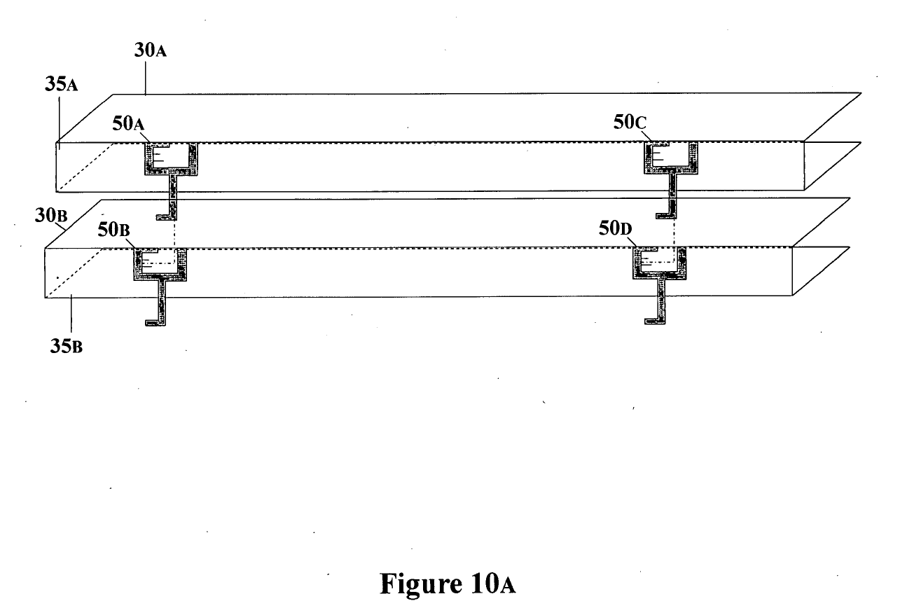

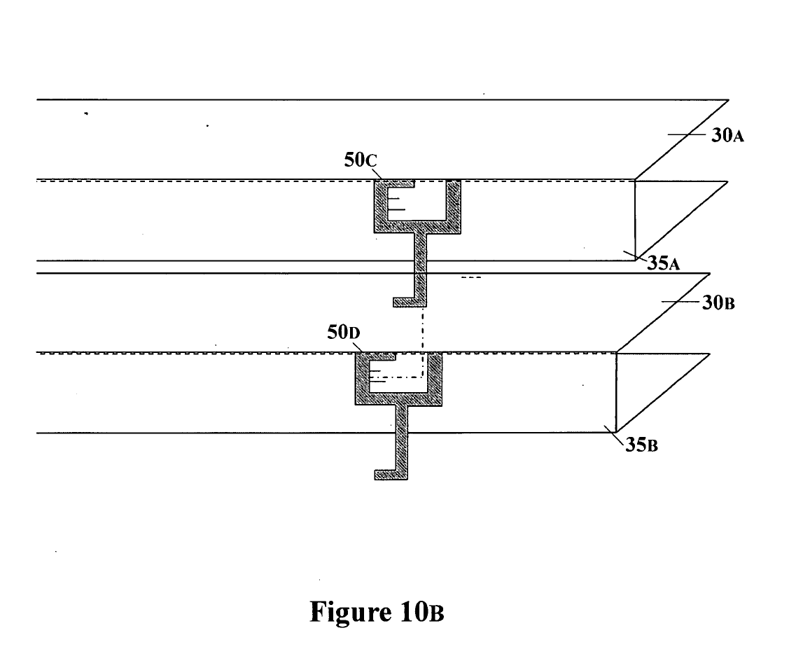

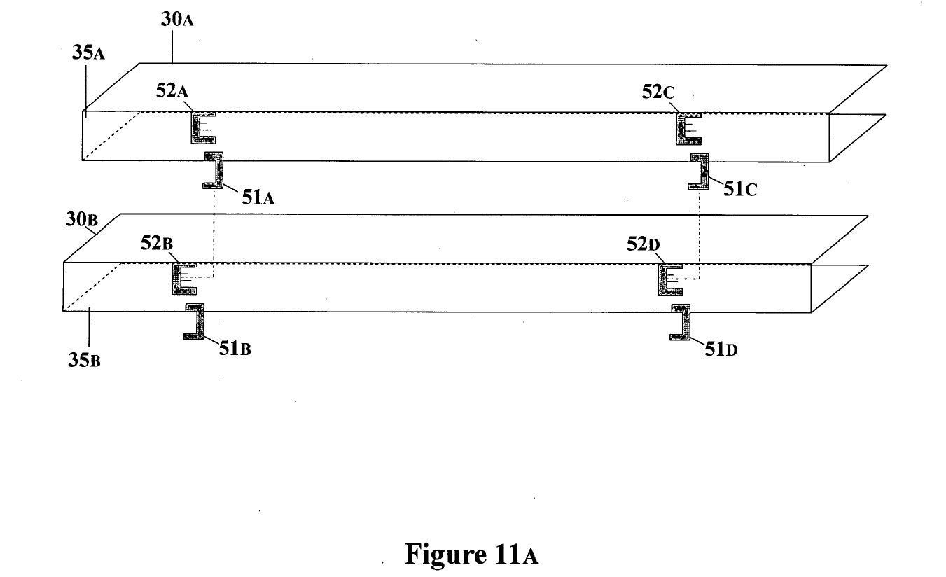

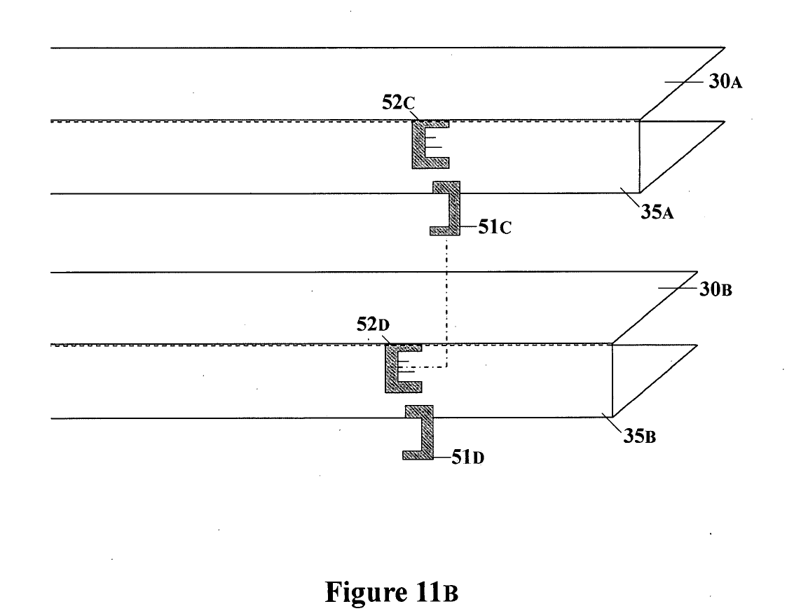

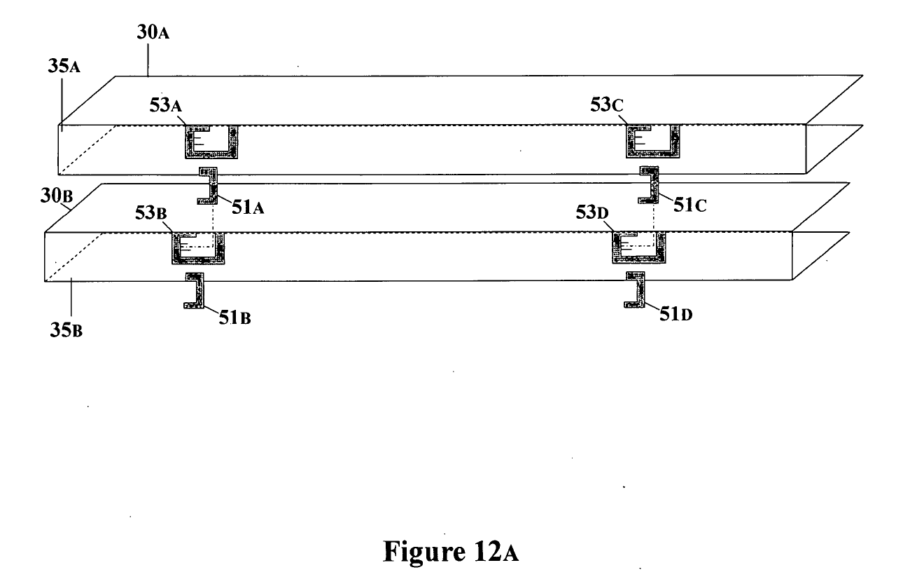

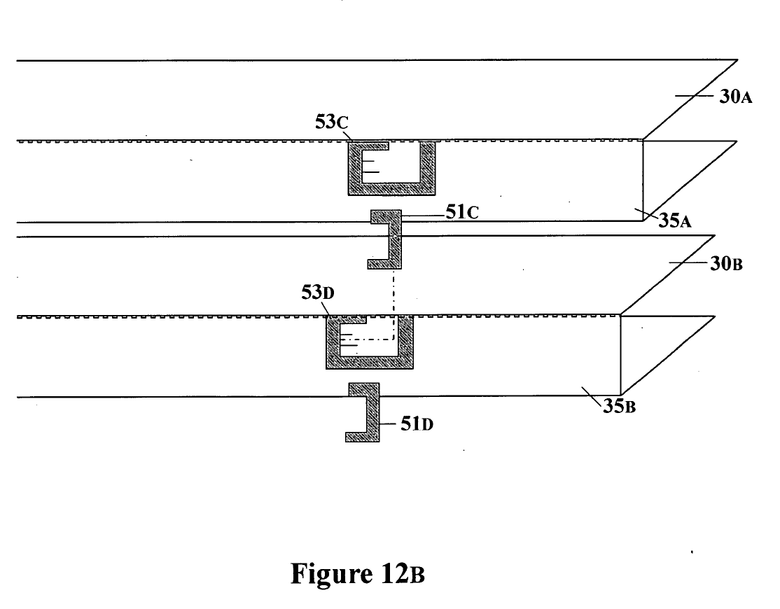

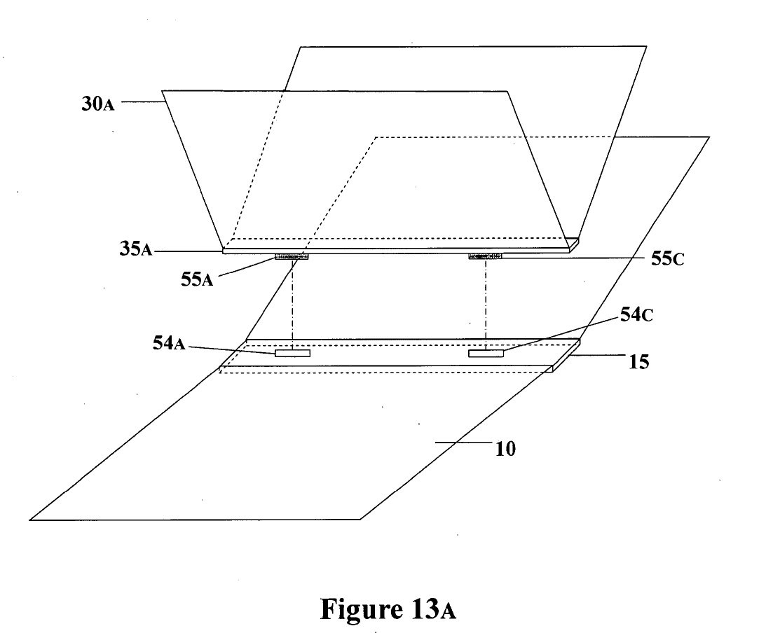

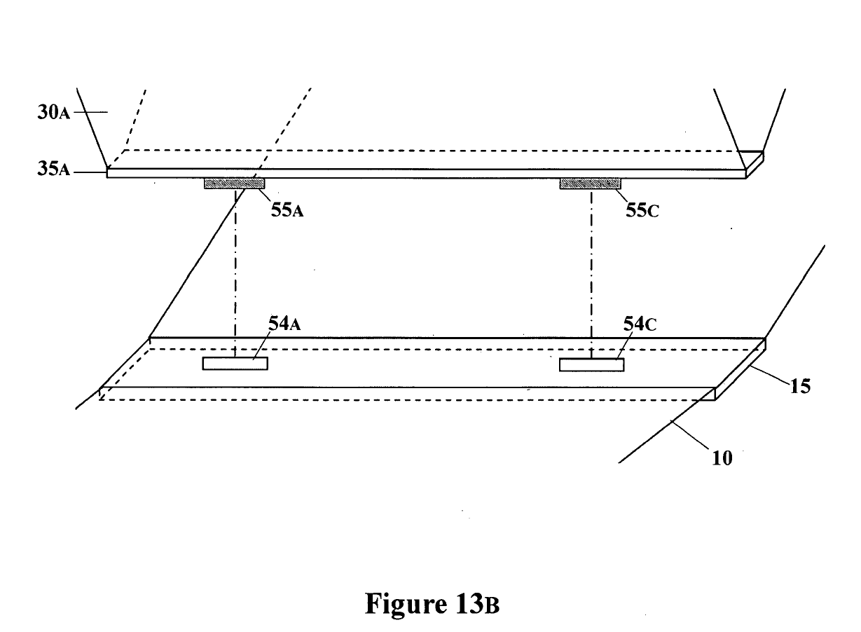

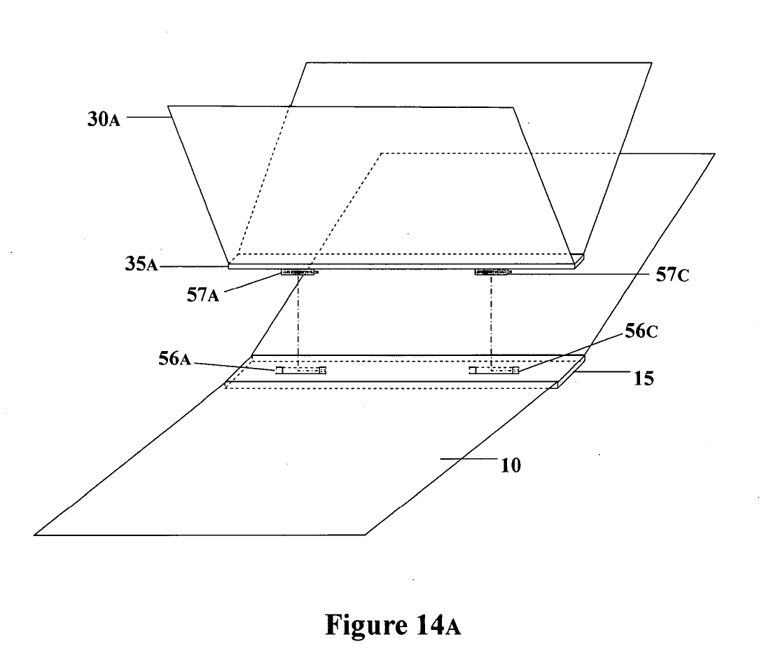

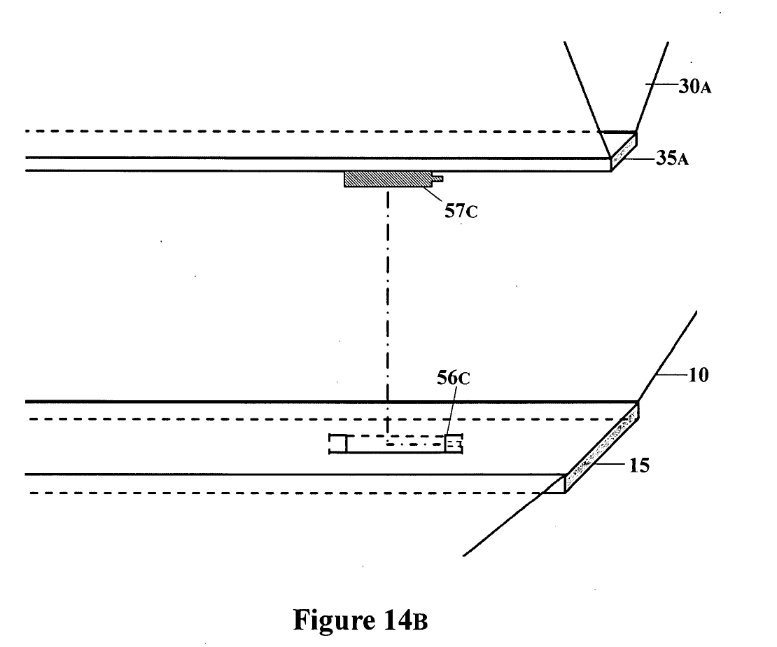

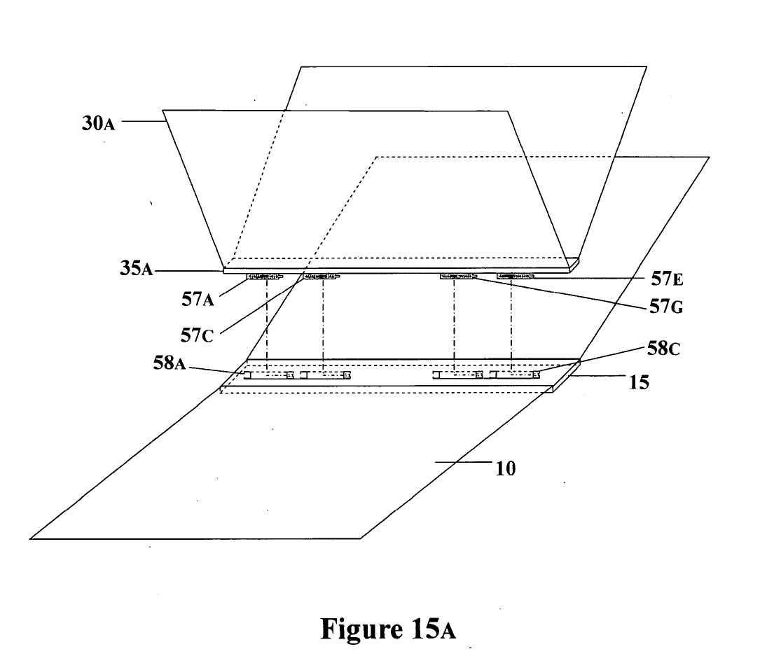

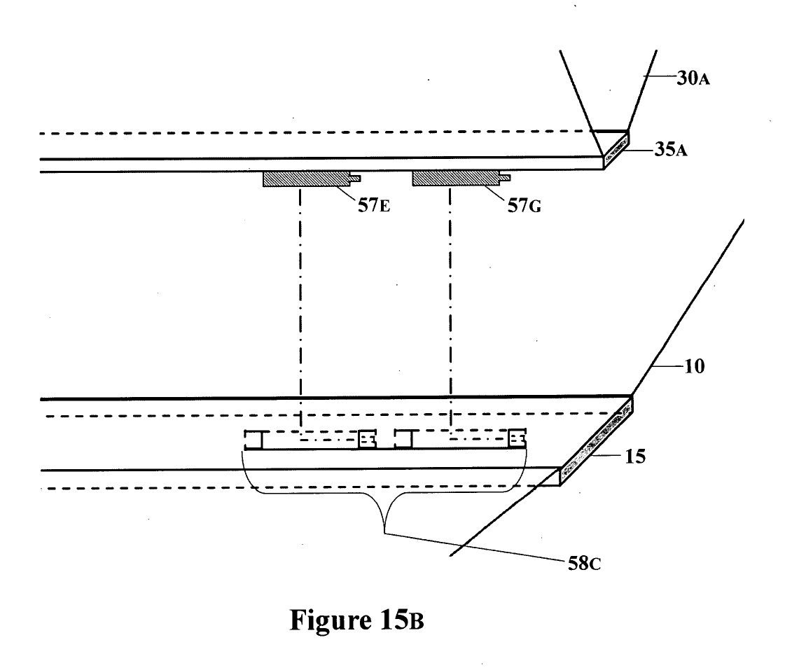

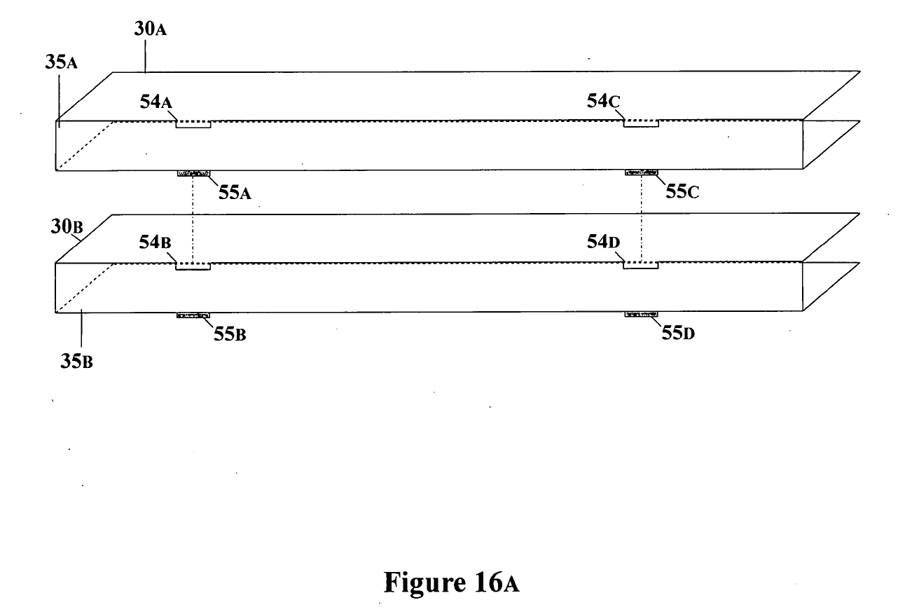

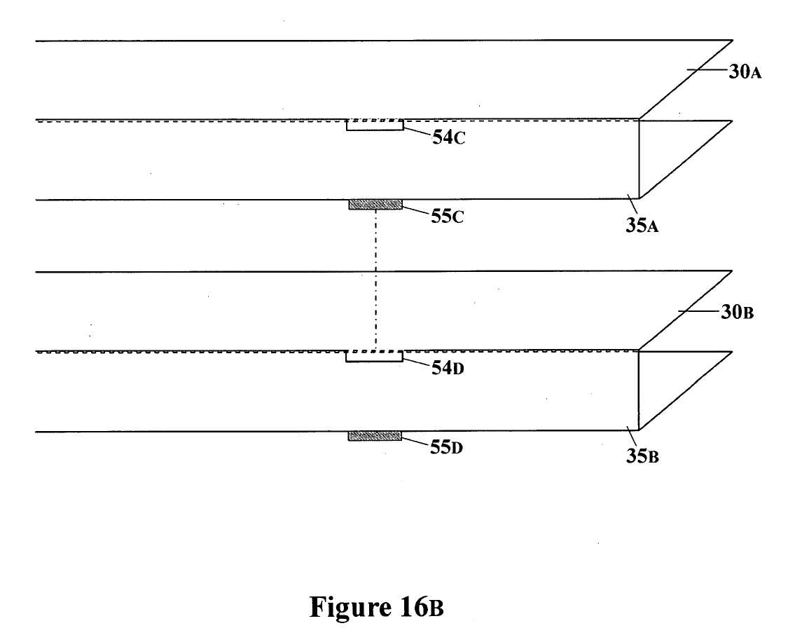

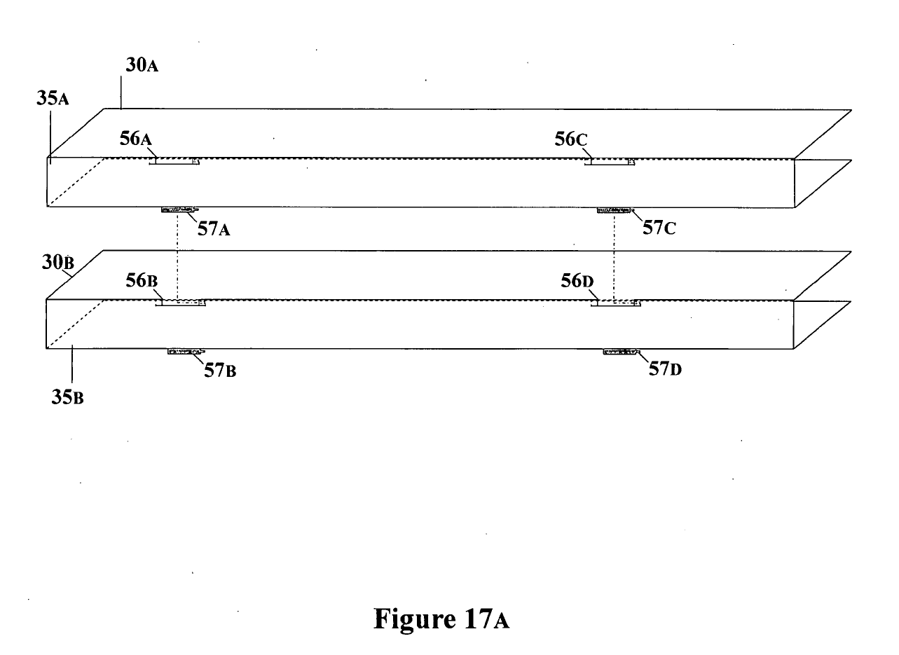

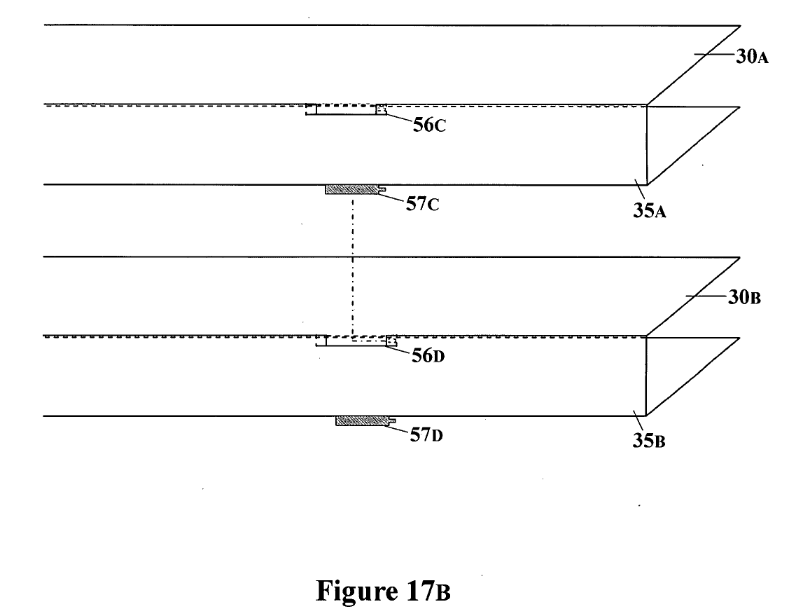

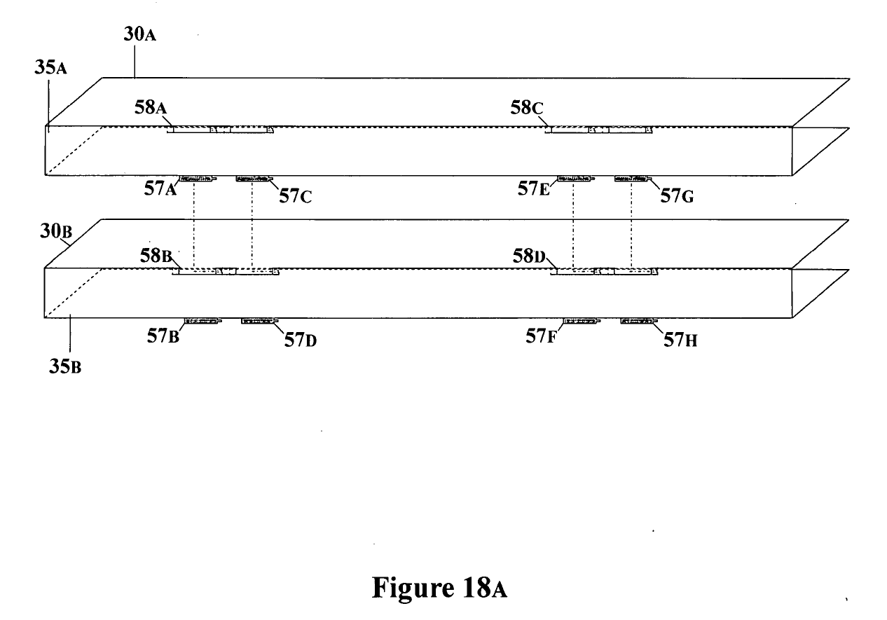

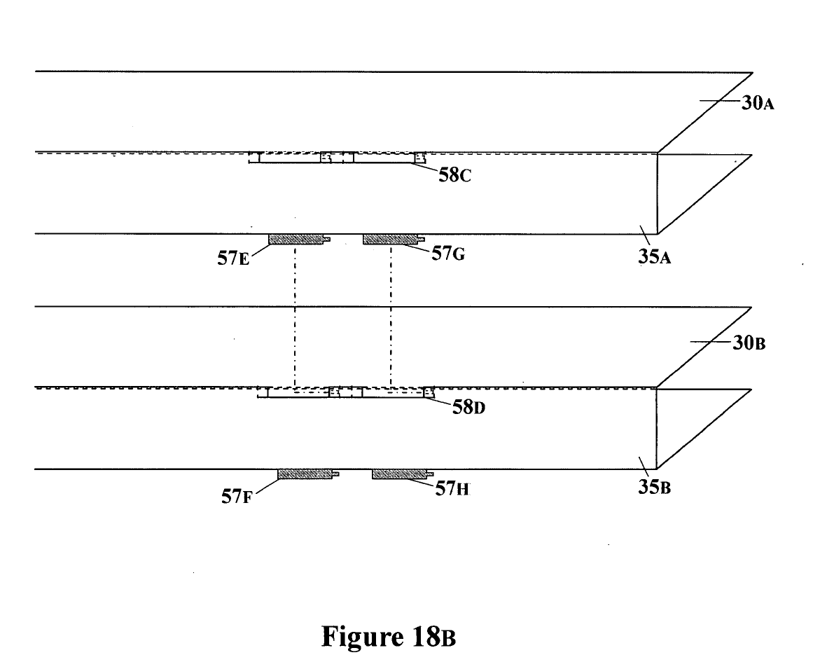

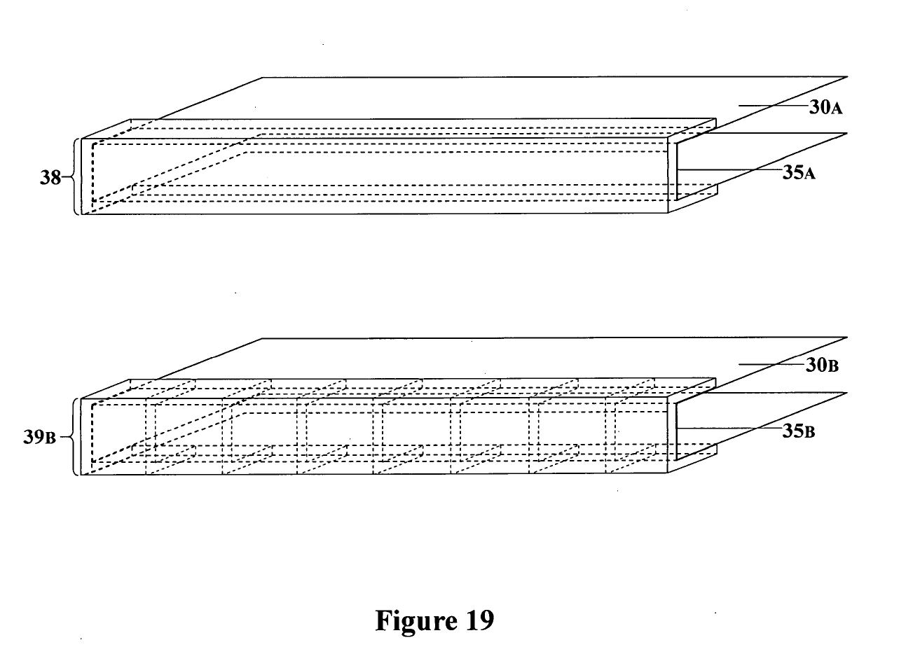

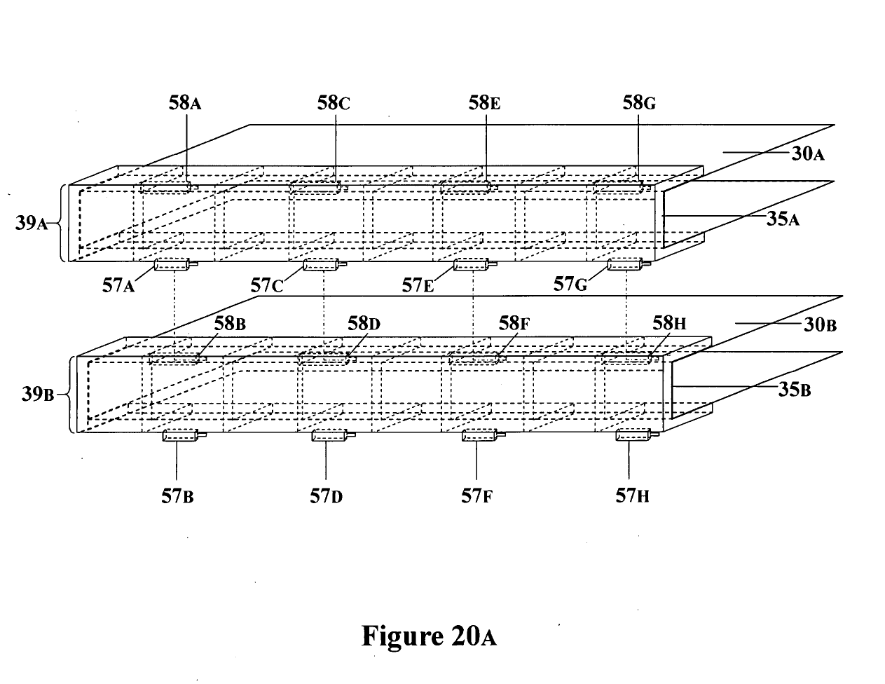

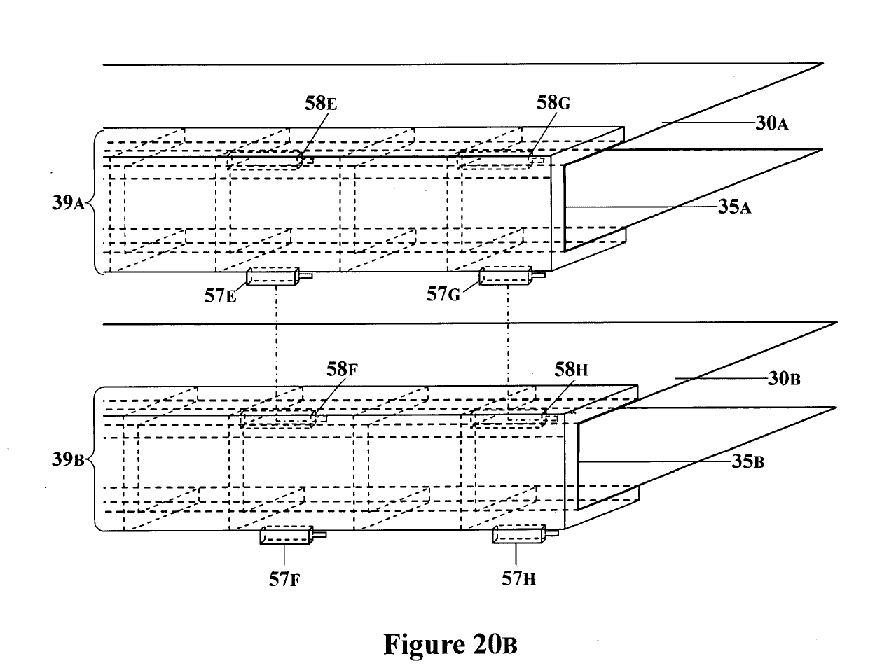

FIGS. 9A and 9B depict an angled tension-release variable groove mechanism between section member 30A and section member 30B. The unique convexities of 49A and 49C compliment the unique concavities of 49B and 49D. In this embodiment, unique attaching members 49B and 49D are located along the edge of the spine region 35B of section member 30B. In this embodiment, unique attaching members 49A and 49C are located along the spine region 35A of section member 30A. This arrangement will allow the section member 30A to attach to section member 30B by inserting the unique convexities of 49A and 49C into one of the various complimentary tension grooves within the unique concavities of attaching members 49B and 49D, respectively.

FIGS. 10A and 10B depict an angled tension-release variable groove channel mechanism between section member 30A and section member 30B. The unique convexities of 50A and 50C compliment the unique concavities of 50B and 50D. In this embodiment, unique attaching members 50B and 50D are located along the edge of the spine region 35B of section member 30B. In this embodiment, unique attaching members 50A and 50C are located along the spine region 35A of section member 30A. This arrangement will allow the section member 30A to attach to section member 30B by inserting the unique convexities of 50A and 50C into one of the various complimentary tension grooves within the unique channel concavities of attaching members 50B and 50D, respectively.

FIGS. 11A and 11B depict an alternative angled tension-release variable groove mechanism between section member 30A and section member 30B. The unique convexities 51A and 51C compliment the unique concavities of 52B and 52D. In this embodiment, unique convexities 51B and 51D and unique concavities 52B and 52D are located along the spine region 35B of section member 30B. In this embodiment, unique convexities 51A and 51C and unique concavities 52A and 52C are located along the spine region 35A of section member 30A. This arrangement will allow the section member 30A to attach to section member 30B by inserting the unique convexities of 51A and 51C into one of the various complimentary tension grooves within the unique concavities of attaching members 52B and 52D, respectively.

FIGS. 12A and 12B depict an alternative tension-release variable groove channel mechanism between section member 30A and section member 30B. The unique convexities 51A and 51C compliment the unique concavities of 53B and 53D. In this embodiment, unique convexities 51B and 51D and unique concavities 53B and 53D are located along the spine region 35B of section member 30B. In this embodiment, unique convexities 51A and 51C and unique concavities 53A and 53C are located along parallel planes the spine region 35A of section member 30A. This arrangement will allow the section member 30A to attach to section member 30B by inserting unique convexities 51A and 51C into one of the various complimentary tension grooves within the complimentary unique channel concavities 53B and 53D, respectively.

FIGS. 13A and 13B depict a tension groove channel mechanism between section member 30A and book cover 10. The unique convexities 55A and 55C compliment the unique concavities of 54A and 54C. In this embodiment, unique convexities 55A and 55C are placed along the spine region 35A of section member 30A. In this embodiment, unique channel concavities 54A and 54C are placed along the interior of the spine region 15 of book cover 10. This arrangement will allow the section member 30A to attach to book cover 10 by inserting unique convexities 55A and 55C into the complimentary unique channel concavities 54A and 54C, respectively.

FIGS. 14A and 14B depict an interlocking channel mechanism between section member 30A and book cover 10. The unique convexities 57A and 57C compliment the unique concavities of 56A and 56C. In this embodiment, unique convexities 57A and 57C are placed along the spine region 35A of section member 30A. In this embodiment, unique channel concavities 56A and 56C are placed along the interior of the spine region 15 of book cover 10. This arrangement will allow the section member 30A to attach to book cover 10 by inserting and adjoining unique convexities 57A and 57C into the complimentary unique concavities 56A and 56C, respectively. The unique adjoining elements in attaching members 57A and 57C allows attached section member 30A and book cover 10 to rotate around the axis created by these unique adjoining elements and complimentary unique adjoining elements in attaching members 56A and 56C.

FIGS. 15A and 15B depict an alternative interlocking channel mechanism between section member 30A and book cover 10. The unique convexities 57A, 57C, 57E, and 57G compliment the unique channel concavities of 58A and 58C. In this embodiment, unique concavities 58A and 58C are placed along the interior spine region 15 of book cover 10. In this embodiment, unique convexities 57A, 57C, 57E, and 57G are placed along the spine region 35A of section member 30A. This arrangement will allow the section member 30A to attach to book cover 10 by inserting and adjoining unique convexities 57A and 57C into the complimentary unique concavity 58A and unique convexities 57E and 57G into unique concavity 58C. The unique adjoining elements in attaching members 57A, 57C, 57E, and 57G allows attached section members 30A and book cover to rotate around the axis created by these unique adjoining elements and complimentary unique adjoining elements in attaching members 58A and 58C.

FIGS. 16A and 16B depict an additional tension groove channel mechanism between section member 30A and section member 30B. The unique convexities 55A and 55C compliment the unique concavities of 54B and 54D. In this embodiment, unique convexities 55B and 55D and unique channel concavities 54B and 54D are placed along parallel planes near the spine region 35B of section member 30B. In this embodiment, unique convexities 55A and 55C and unique channel concavities 54A and 54C are placed along parallel planes near the spine region 35A of section member 30A. This arrangement will allow the section member 30A to attach to section member 30B by inserting unique convexities 55A and 55C into the complimentary unique channel concavities 54B and 54D, respectively.

FIGS. 17A and 17B depict an additional interlocking channel mechanism between section member 30A and section member 30B. The unique convexities 57A and 57C compliment the unique concavities of 56B and 56D. In this embodiment, unique convexities 57B and 57D and unique channel concavities 56B and 56D are placed along parallel planes near the perpendicular plane of the of the spine region 35B of section member 30B. In this embodiment, unique convexities 57A and 57C and unique channel concavities 56A and 56C are placed near and along the spine region 35A of section member 30A. This arrangement will allow the section member 30A to attach to section member 30B by inserting and adjoining unique convexities 57A and 57C into the complimentary unique concavities 56B and 56D, respectively. The unique adjoining elements in attaching members 57A and 57C allows attached section members 30A and 30B to rotate around the axis created by these unique adjoining elements and complimentary unique adjoining elements in attaching members 56B and 56D.

FIGS. 18A and 18B depict another interlocking channel mechanism between section member 30A and section member 30B. The unique convexities 57A, 57C, 57E, and 57G compliment the unique channel concavities of 58B and 58D. In this embodiment, unique convexities 57B, 57D, 57F, and 57H and unique concavities 58B and 58D are placed near and along the spine region 35B of section member 30B. In this embodiment, unique convexities 57A, 57C, 57E, and 57G and unique concavities 58A and 58C are placed near and along the spine region 35A of section member 30A. This arrangement will allow the section member 30A to attach to section member 30B by inserting and adjoining unique convexities 57A and 57C into the complimentary unique concavity 58B and unique convexities 57E and 57G into unique concavity 58D. The unique adjoining elements in attaching members 57A, 57C, 57E, and 57G allows attached section members 30A and 30B to rotate around the axis created by these unique adjoining elements and complimentary unique adjoining elements in attaching members 58B and 58D.

FIG. 19 shows examples of unique alternative spine regions of section members 30A and 30B. Alternative spine region 38 depicts a material of a certain length on and/or in which the attaching members described in FIG. 1 through FIG. 18B of the present invention may be added. Alternative spine region 39B depicts a material of variable length on and/or in which the attaching members described in FIG. 1 through FIG. 18B of the present invention may be added. As shown here, the alternative spine regions 38 may be attached to the spine region 35A of section member 30A in a permanent or non-permanent fashion. As shown here, the alternative spine regions 39B may be attached to the spine region 35B of section member 30B in a permanent or non-permanent fashion.

FIGS. 20A and 20B show an example of using an alternative spine region containing unique attaching elements to connect section members 30A and 30B. Both alternative spine regions 39A and 39B contain perforated elements, which allow a user to vary the length of the spine region accordingly. In this example, unique convexities 57A, 57C, 57E, and 57G are added to the alternative spine region 39A. Unique complimentary concavities 58A, 58C, 58E, and 58G are also added to alternative spine region 39A along the opposite plane. Alternative spine region 39A while containing the unique and complimentary attaching elements 57A, 57C, 57E, 57G, 58A, 58C, 58E, and 58G is attached to spine region 35A of section member 30A via a permanent or non-permanent fashion, such as, but not limited to, a durable adhesive. Also in this example, unique convexities 57B, 57D, 57F, and 57H are added to the alternative spine region 39B. Unique complimentary concavities 58B, 58D, 58F, and 58H are also added to alternative spine region 39B along the opposite plane. Alternative spine region 39B while containing the unique and complimentary attaching elements 57B, 57D, 57F, 57H, 58B, 58D, 58F, and 58H is attached to spine region 35B of section member 30B via a permanent or non-permanent fashion, such as, but not limited to, a durable adhesive. This arrangement will allow the section member 30A to attach to section member 30B by inserting and adjoining unique convexities 57A, 57C, 57E, and 57G into the complimentary unique concavities 58B, 58D, 58F, and 58H, respectively. The unique adjoining elements in attaching members 57A, 57C, 57E, and 57G allows attached section members 30A and 30B to rotate around the axis created by these unique adjoining elements and complimentary unique adjoining elements in attaching members 58B, 58D, 58F, and 58G.

One of the many uses of the present invention is for books that are traditionally bulky and heavy, and which may require updates and additional versions to be reprinted in an effort to contain the most current information. Sections of the book may be republished with the most up-to-date material. Users of the book may also choose to separate sections of the text from the whole by detaching the sections from the book cover. The sections may be removed by sliding and/or pulling the individually-bound section members from another section member and/or book cover.

As previously mentioned in the present disclosure, variations in the above embodiments include a plurality of the adjoining members described for each embodiment. Each of the above mechanisms depicted in a unique drawing is merely exemplary of the invention as described herein and claimed within the scope of the present application.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for supporting a printed matter, the device comprising:
two or more components of a printed matter; and
a sliding and/or hooking mechanism on each component to use for attachment to another component.

2. The system of claim 1, wherein the component is a section of the printed matter.

3. The system of claim 1, wherein the component is a cover for the printed matter.

4. The system of claim 1, wherein the components include a combination of sections of the printed matter and a cover.

5. The system of claim 1, wherein the mechanism includes complementary elements on each component.

6. The system of claim 5, wherein each component includes at least one set of complementary elements.

7. The system of claim 6, wherein the complementary components include tongue and groove.

8. The system of claim 6, wherein the complementary components include convexities and concavities.

9. The system of claim 6, wherein the complementary components include snap fit elements.

10. The system of claim 6, wherein the complementary components include a cavity.

11. A book with detachable sections, comprising:
a book cover;
individually bound sections containable within the book cover; and
a sliding and/or hooking mechanism on the book cover and/or the sections to use for attachment to the cover and/or another section.

12. The book of claim 11, wherein the mechanism includes complementary elements on the cover and sections.

13. The book of claim 11, wherein the cover and sections include at least one set of complementary elements.

14. The book of claim 13, wherein the complementary components include tongue and groove.

15. The book of claim 13, wherein the complementary components include convexities and concavities.

16. The book of claim 13, wherein the complementary components include snap fit elements.

17. The book of claim 13, wherein the complementary components include a cavity.

18. A method of maintaining various components of a printed matter together, the method comprising:
attaching the components to each other through use of complementary elements on each component through a sliding and/or hooking mechanism.

19. The method of claim 18, wherein the component is a section of the printed matter.

20. The method of claim 18, wherein the component is a cover for the printed matter.
